(19) United States
(12) Patent Application Publication
(10) Pub. No.: US 2026/0263974 A1
(43) Pub. Date: Sep. 10, 2026

(54) DEVICE FOR CONTROLLING A WASHING MACHINE

(71) Applicant: ABZ Zierler GmbH & Co. KG, Bad Ischl (AT)

(72) Inventor: Peter Zierler, Bad Ischl (AT)

(21) Appl. No.: 19/072,998

(22) Filed: Mar. 6, 2025

(51) Int. Cl. D06F 39/08; D06F 34/22; D06F 39/10; D06F 103/18

(52) U.S. Cl. CPC D06F 39/085; D06F 34/22; D06F 39/10; D06F 2103/18

(57) ABSTRACT

A device for controlling a washing machine depending on the degree of contamination of the washing liquid comprises a filter device that can be supplied with a washing liquid from the washing machine and has a horizontally arranged, rotating screen drum, through which the washing liquid flows from the inside to the outside. A discharge screw conveyor is arranged inside the screen drum, below its vertex region, and passes through the screen drum on an end face on the discharge side. A cleaning device has cleaning nozzles that are provided outside the screen drum that are directed towards the screen drum, and that can be supplied with a pressurized medium. A control device controls the washing machine or the cleaning device depending on an output signal of a level indicator for the washing liquid in the screen drum.

The invention relates to a device for controlling a washing machine depending on the degree of contamination of the washing liquid.

The amount of energy, detergent and washing liquid required to clean an item depends on the degree of contamination of the item to be washed. Since the degree of contamination of the washing liquid is directly related to the degree of contamination of the items to be washed, it has already been proposed (DE 19714695A1 ) to determine the degree of contamination of the washing liquid and, depending on this, to control the washing machine with regard to energy and washing liquid consumption. The degree of contamination of the washing liquid is determined by measuring the turbidity of the washing liquid using radiation that is transmitted through the washing liquid in a pipe area. This requires pipe areas that are permeable to radiation, which have to be thoroughly maintained. Furthermore, it is assumed that the washing liquid is contaminated homogeneously throughout the washing liquid volume, which does not occur in practice.

In order to continuously separate solid particles from a turbid liquid, it is also known (AT 501 462A1 ) to provide a horizontally arranged, rotating screen drum into which the turbid liquid is supplied. While the liquid portion of the turbid liquid discharges through the screen drum's screen jacket, the solid particles retained by the screen jacket are conveyed with the rotating screen drum to the upper vertex region, from where they drop to a discharge screw conveyor. By means of the discharge screw conveyor, the separated solid particles are discharged from the end face of the screen drum. To clean the screen drum, cleaning nozzles are provided above the screen drum, directed towards the screen drum, which are supplied with a pressurized medium so that the solid particles depositing on the screen drum from the inside are loosened by the pressurized medium flowing through the screen drum from the outside inwards and fall off to the discharge screw conveyor. However, such a device for continuously separating solid particles from a turbid liquid is not suitable for controlling a washing machine depending on the degree of contamination of the washing liquid.

The invention is based on the task of providing a favorable, reliable device for controlling a washing machine.

The invention solves the set task by the fact that the device for controlling a washing machine comprises:
a filter device which can be supplied with a washing liquid from the washing machine and which has a horizontally arranged, rotating screen drum, through which the washing liquid flows from the inside to the outside, and a discharge screw conveyor which is arranged inside the screen drum, below its vertex region, and passes through the screen drum on an end face on the discharge side,
a cleaning device with cleaning nozzles that are provided outside the screen drum, directed towards the screen drum and can be supplied with a pressurized medium,
level indicator for the washing liquid in the screen drum and
a control device which, on the one hand, controls the washing machine and, on the other hand, the cleaning device in dependence on an output signal of the level indicator.

The invention makes use of the finding that, with a continuous supply of the washing liquid to the filter device, the level of the washing liquid in the screen drum depends on the degree of contamination of the washing liquid, i.e. on the distribution density of the solid particles. The level of washing liquid in the screen drum can therefore be used as a measure of the degree of contamination of the washing liquid and, depending on this, a control device for the washing machine can be actuated.

Depending on the degree of contamination of the washing liquid, the washing machine can thus be actuated in accordance with the program, for example with regard to the mechanical movement of the items to be washed, the duration of the washing and rinsing process, the temperature of the washing liquid and the dosage of washing chemicals.

The filtered washing liquid that discharges from the screen drum can be advantageously reintroduced into the washing machine or stored for a new washing process.

The level of the washing liquid in the screen drum also indicates an increasing, permanent deposit of solid particles on the screen drum jacket and thus the need to clean the screen drum jacket. For this purpose, the cleaning nozzles of the cleaning device are supplied with a pressurized medium via the control device, which flows through the screen drum jacket from the outside to the inside, particularly in the vertex region, so that the solid particles are loosened from the inside of the screen drum jacket and fall to the discharge screw conveyor and are discharged from the screen drum at the end face. Washing liquid or compressed air can be used as the pressurized medium.

Particularly simple and robust conditions for determining the level of the washing liquid retained in the screen drum are obtained when the level indicator has a float that actuates switching contacts associated with individual liquid levels.

The drawing illustrates the subject of the invention, for example.

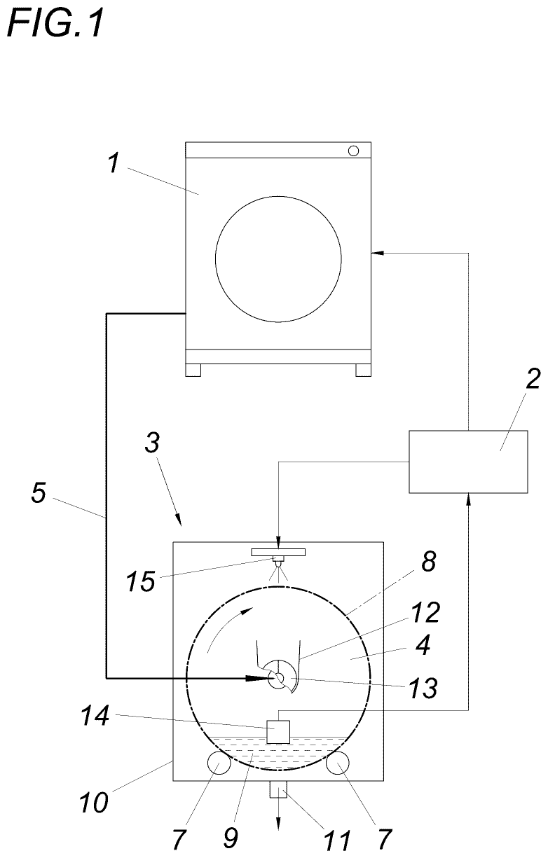

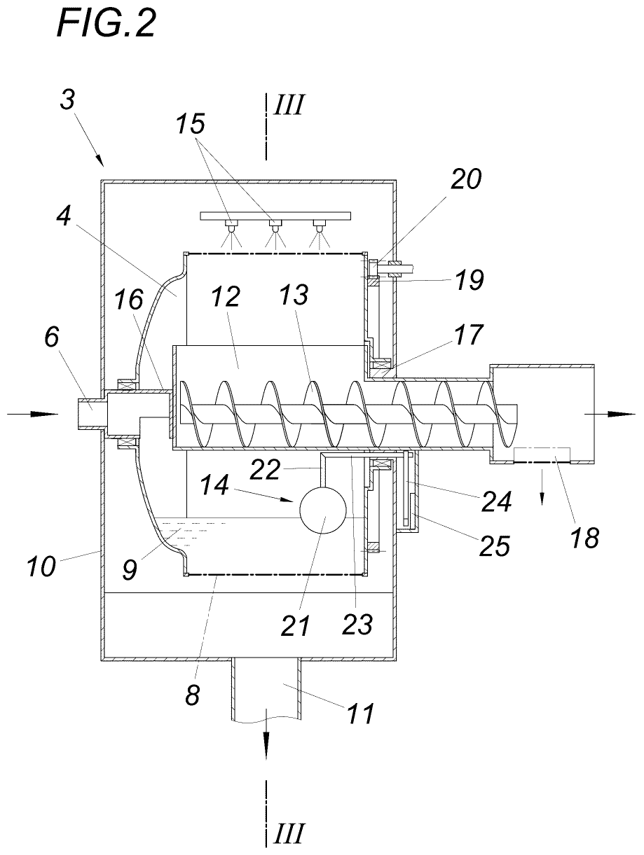

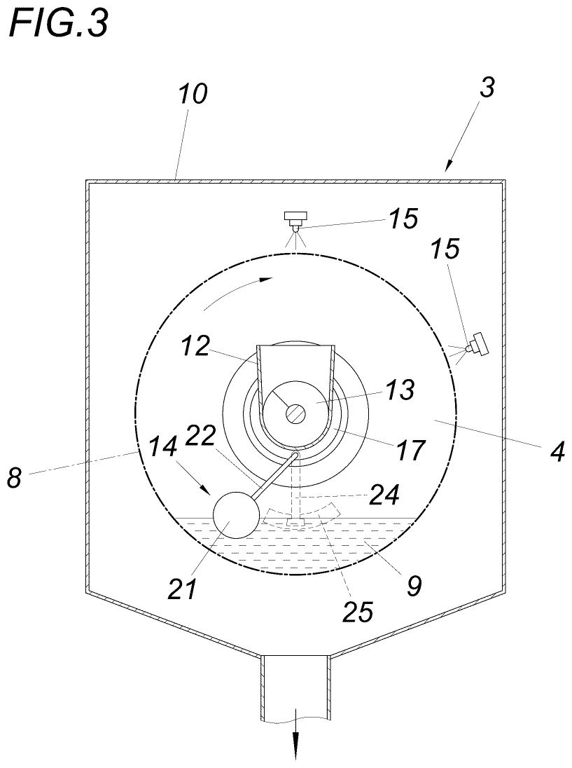

FIG. 1 shows a device for controlling a washing machine according to the invention in a schematic block diagram,
FIG. 2 shows the filter device of the device in a schematic longitudinal section and
FIG. 3 shows a section according to line III-III of FIG. 2.

As shown in the block diagram in FIG. 1, a washing machine 1 is controlled by a control device 2, by means of which different washing programs can be selected in order to operate the washing machine depending on the degree of contamination of the washing, taking into account a good washing result, in particular with regard to the optimal use of energy and detergent. For this purpose, a filter device 3 is used which is continuously supplied with washing liquid from the washing machine 1. which has a horizontal screen drum 4 into which washing liquid from the washing machine 1 is introduced through a supply line 5, namely through an inflow 6 on the end face. The screen drum 4 is driven in rotation about its axis, as indicated in FIG. 1 by the drive wheels 7. The washing liquid supplied to the screen drum 4 flows through the screen drum jacket 8 from the inside to the outside, whereby a retention 9 dependent on the degree of contamination of the liquid occurs within the screen drum 4. The cleaned washing liquid flowing through the screen drum jacket 8 is drained from the housing 10 accommodating the screen drum 4 through an outlet 11, for example to be fed back to the washing machine 1 or stored in a collecting tank for further use. To ensure an appropriate filtering effect, the screen drum jacket 8 has a wire filter mesh, although this is not mandatory.

The solid particles contained in the washing liquid are retained by the screen drum jacket 8 on the inside of the jacket and, due to the rotation of the screen drum 4, are carried upwards into the vertex region of the screen drum. In the upper vertex region, the solid particles fall under the force of gravity from the screen drum jacket 8 into a collecting channel 12, from which they are discharged by a discharge screw conveyor 13, which passes through the screen drum 4 on the end face opposite the inflow 6 for the washing liquid.

Since the level of the retention 9 in the screen drum 4 depends on the distribution density of the solid particles in the supplied washing liquid and the distribution density of the solid particles is a measure of the contamination of the washing liquid, a control signal for controlling the control device 2 for the washing machine can be provided by a level indicator 14 for the retention 9 of the washing liquid in the screen drum 4, which is dependent on the degree of contamination of the washing liquid.

The solid particles that deposit on the inside of the screen drum jacket 8 are not completely discharged from the screen drum 4 by the discharge screw conveyor 13, which leads to a gradually increasing obstruction of the screen drum jacket 8. The associated increase in the level of retention 9 of the washing liquid in the screen drum 4 is detected by the level indicator 14 and can be used to actuate a cleaning device. For this purpose, cleaning nozzles 15 directed towards the screen drum jacket 8 are provided outside the screen drum 4, in particular in its upper vertex region, and are supplied with a pressurized medium by means of the control device 2, so that the solid particles adhering to the inside of the screen drum jacket 8 are loosened and fall into the collecting channel 12.

In FIGS. 2 and 3, a filter device 3 is shown in more detail. The screen drum 4 is rotatably mounted in a housing 10, namely in the area of one end face on a bearing axis 16 that is fixed to the housing and is advantageously formed by the inflow 6 for the washing liquid. A bearing flange 17 of the housing 10 is provided for the screen drum 4 on the opposite end face. The discharge screw conveyor 13 is guided through this bearing flange 17, and its housing opens inside the screen drum 4 to form a collecting channel 12. While the solid particles are discharged axially from the housing of the discharge screw conveyor 13, the washing liquid residues are separated by a filter insert 18.

There are various embodiments for driving the screen drum 4. In FIG. 2, a gear ring 19 arranged on one end face is provided for this purpose, which meshes with a driving sprocket 20.

The level indicator 14 for the retention 9 of the washing liquid in the screen drum 4 is embodied as a float 21, which is arranged on a lever arm 22 of a shaft 23 that passes through the bearing flange 17 and actuates a switch lever 24, which interacts with a switch bar 25 provided with switch contacts. Depending on the rotational position of the shaft 23 and thus depending on the level of the retention 9 of the washing liquid in the screen drum 4, different switch contacts associated with individual levels are actuated, which apply corresponding control signals to the control device 2.

1. A device for controlling a washing machine, said device comprising:
a filter device that is configured to be supplied with a washing liquid from the washing machine and that has a horizontally-arranged rotating screen drum, through which the washing liquid flows from an inside thereof to an outside thereof, and a discharge screw conveyor that is arranged inside the screen drum, below a vertex region thereof, and passes through the screen drum on an end face on a discharge side,
a cleaning device with cleaning nozzles that are provided outside the screen drum, directed towards the screen drum and can be supplied with a pressurized medium;
a level indicator outputting an output signal based on a level of the washing liquid in the screen drum; and
a control device that controls either the washing machine or the cleaning device responsive to the output signal of the level indicator.

2. A device according to claim 1, wherein the level indicator has a float that actuates switch contacts that are each associated with respective individual liquid levels.
